(19) United States
(12) Patent Application Publication
(10) Pub. No.: US 2026/0042364 A1
(43) Pub. Date: Feb. 12, 2026

(54) CHARGING MULTIPLE ELECTRIC VEHICLES WITH A SINGLE CHARGER

(71) Applicant: GM Global Technology Operations LLC, Detroit, MI (US)

(72) Inventors: Paul Rabahy, Royal Oak, MI (US); Jacob Adam St. George, Royal Oak, MI (US); Alexander T. Marlow, Center Line, MI (US)

(21) Appl. No.: 18/798,208

(22) Filed: Aug. 8, 2024

(51) Int. Cl. B60L 53/10; B60L 53/62; B60L 53/67

(52) U.S. Cl. CPC B60L 53/11; B60L 53/62; B60L 53/67; B60L 2210/10

(57) ABSTRACT

A system for direct current (DC) charging for electric vehicles may include a DC charger having a DC charger charging port. The system further may include a plurality of low-power access points (LPAPs) each having a first daisy-chain port, a second daisy-chain port, and an LPAP charging port. The plurality of LPAPs are connected in series to the DC charger charging port of the DC charger with the first daisy-chain port and the second daisy-chain port. Each of the plurality of LPAPs is configured to transfer energy from the DC charger to an electric vehicle with the LPAP charging port. The system further may include a plurality of electric vehicles. Each of the plurality of electric vehicles is connected to the LPAP charging port of one of the plurality of LPAPs to charge the plurality of electric vehicles.

### INTRODUCTION

The present disclosure relates to systems and methods charging electric vehicles.

Electric vehicle supply equipment (EVSE), including both alternating current (AC) EVSE and direct current (DC) EVSE, has been developed to charge electric vehicles. AC EVSE may reduce development and construction costs, as the AC EVSEs must not perform AC-DC conversion (i.e., rectification). However, vehicles compatible with AC EVSE must integrate AC-DC conversion on-board, which may increase weight and resource use. DC EVSE may provide higher efficiency than AC EVSE and may reduce the weight and resource use of power electronics required on-board vehicles. However, DC EVSE may have increased development and construction costs relative to AC EVSE because DC EVSE must perform AC-DC conversion. Therefore, it is advantageous to most effectively utilize current and future EVSE infrastructure. However, current AC and DC EVSE and industry standard vehicle-to-EVSE communications protocols are designed for simultaneous connection to a single electric vehicle.

Thus, while current electric vehicle charging systems and methods achieve their intended purpose, there is a need for a new and improved system and method for DC charging for electric vehicles.

### SUMMARY

According to several aspects, a system for direct current (DC) charging for electric vehicles is provided. The system may include a DC charger having a DC charger charging port. The system further may include a plurality of low-power access points (LPAPs) each having a first daisy-chain port, a second daisy-chain port, and an LPAP charging port. The plurality of LPAPs are connected in series to the DC charger charging port of the DC charger with the first daisy-chain port and the second daisy-chain port. Each of the plurality of LPAPs is configured to transfer energy from the DC charger to an electric vehicle with the LPAP charging port. The system further may include a plurality of electric vehicles. Each of the plurality of electric vehicles is connected to the LPAP charging port of one of the plurality of LPAPs to charge the plurality of electric vehicles.

In another aspect of the present disclosure, the system further may include an LPAP controller in electrical communication with each of the plurality of LPAPs. The LPAP controller is programmed to determine a battery voltage of each of the plurality of electric vehicles. The LPAP controller is further programmed to control the DC charger and one or more of the plurality of LPAPs to charge one or more of the plurality of electric vehicles based at least in part on the battery voltage of each of the plurality of electric vehicles.

In another aspect of the present disclosure, the LPAP controller is further programmed to identify a lowest battery voltage among the plurality of electric vehicles. The LPAP controller is further programmed to control the DC charger and one or more of the plurality of LPAPs to charge one or more of the plurality of electric vehicles having the lowest battery voltage. The LPAP controller is further programmed to periodically re-evaluate the battery voltage of each of the plurality of electric vehicles, identify the lowest battery voltage, and control the DC charger and one or more of the plurality of LPAPs to charge one or more of the plurality of electric vehicles having the lowest battery voltage.

In another aspect of the present disclosure, at least one of the plurality of LPAPs further may include an electronically controllable switch configured to connect the first daisy-chain port to the LPAP charging port. The electronically controllable switch is configured to be controlled by the LPAP controller.

In another aspect of the present disclosure, to control the DC charger and one or more of the plurality of LPAPs, the LPAP controller is further programmed to command the DC charger to provide a first output voltage at the DC charger charging port. The first output voltage is determined based at least in part on the lowest battery voltage. The LPAP controller is further programmed to control the electronically controllable switch of one or more of the plurality of LPAPs to charge one or more of the plurality of electric vehicles having the lowest battery voltage.

In another aspect of the present disclosure, to control the DC charger and one or more of the plurality of LPAPs, the LPAP controller is further programmed to command the DC charger to limit a current at the DC charger charging port to a first output current. The first output current is determined based at least in part on a maximum charging current of the one or more of the plurality of electric vehicles having the lowest battery voltage.

In another aspect of the present disclosure, the LPAP controller is further programmed to identify a highest battery voltage among the plurality of electric vehicles. The LPAP controller is further programmed to control the DC charger and one or more of the plurality of LPAPs to charge the plurality of electric vehicles based at least in part on the highest battery voltage. The LPAP controller is further programmed to periodically re-evaluate the battery voltage of each of the plurality of electric vehicles, identify the highest battery voltage, and control the DC charger and one or more of the plurality of LPAPs to charge the plurality of electric vehicles based at least in part on the highest battery voltage.

In another aspect of the present disclosure, each of the plurality of LPAPs further may include a DC-DC converter connected between the first daisy-chain port and the LPAP charging port. The DC-DC converter is configured to be controlled by the LPAP controller.

In another aspect of the present disclosure, to control the DC charger and one or more of the plurality of LPAPs, the LPAP controller is further programmed to command the DC charger to provide a second output voltage at the DC charger charging port. The second output voltage is determined based at least in part on the highest battery voltage. To control the DC charger and one or more of the plurality of LPAPs, the LPAP controller is further programmed to control the DC-DC converter of each of the plurality of LPAPs to charge each of the plurality of electric vehicles based at least in part on the battery voltage of each of the plurality of electric vehicles.

In another aspect of the present disclosure, to control the DC-DC converter of each of the plurality of LPAPs, the LPAP controller is further programmed to determine a plurality of voltage differences between the second output voltage and the battery voltage of each of the plurality of electric vehicles. To control the DC-DC converter of each of the plurality of LPAPs, the LPAP controller is further programmed to control the DC-DC converter of each of the plurality of LPAPs based at least in part on one of the plurality of voltage differences.

According to several aspects, a system for direct current (DC) charging for electric vehicles is provided. The system may include a DC charger having a DC charger charging port. The system further may include a first low-power access point (LPAP) having a first LPAP first daisy-chain port, a first LPAP second daisy-chain port, a first LPAP charging port, and a first LPAP controller. The first LPAP first daisy-chain port is connected to the DC charger charging port. The system further may include a second low-power access point (LPAP) having a second LPAP first daisy-chain port, a second LPAP second daisy-chain port, a second LPAP charging port, and a second LPAP controller. The second LPAP first daisy-chain port is connected to the first LPAP second daisy-chain port. The second LPAP controller is in electrical communication with the first LPAP controller. The first LPAP controller and the second LPAP controller are programmed to determine a battery voltage of a first electric vehicle connected to the first LPAP charging port and a second electric vehicle connected to the second LPAP charging port. The first LPAP controller and the second LPAP controller are further programmed to control the DC charger, the first LPAP, and the second LPAP to charge one or more of: the first electric vehicle and the second electric vehicle based at least in part on the battery voltage of the first electric vehicle and the second electric vehicle.

In another aspect of the present disclosure, the first LPAP further may include a first electronically controllable switch configured to connect the first LPAP first daisy-chain port to the first LPAP charging port. The first electronically controllable switch is configured to be controlled by the first LPAP controller. The second LPAP further may include a second electronically controllable switch configured to connect the second LPAP first daisy-chain port to the second LPAP charging port. The second electronically controllable switch is configured to be controlled by the second LPAP controller.

In another aspect of the present disclosure, the first LPAP controller and the second LPAP controller are further programmed to identify a lowest battery voltage among the first electric vehicle and the second electric vehicle. The first LPAP controller and the second LPAP controller are further programmed to control the DC charger, the first electronically controllable switch of the first LPAP, and the second electronically controllable switch of the second LPAP to charge one or more of: the first electric vehicle and the second electric vehicle having the lowest battery voltage. The first LPAP controller and the second LPAP controller are further programmed to periodically re-evaluate the battery voltage of the first electric vehicle and the second electric vehicle, identify the lowest battery voltage, and control the DC charger, the first electronically controllable switch of the first LPAP, and the second electronically controllable switch of the second LPAP to charge one or more of: the first electric vehicle and the second electric vehicle having the lowest battery voltage.

In another aspect of the present disclosure, to control the DC charger, the first electronically controllable switch of the first LPAP, and the second electronically controllable switch of the second LPAP, the first LPAP controller and the second LPAP controller are further programmed to command the DC charger to provide a first output voltage at the DC charger charging port using the first LPAP controller. The first output voltage is determined based at least in part on the lowest battery voltage. To control the DC charger, the first electronically controllable switch of the first LPAP, and the second electronically controllable switch of the second LPAP, the first LPAP controller and the second LPAP controller are further programmed to control the first electronically controllable switch of the first LPAP and the second electronically controllable switch of the second LPAP to charge one or more of: the first electric vehicle and the second electric vehicle having the lowest battery voltage.

In another aspect of the present disclosure, the first LPAP further may include a first DC-DC converter connected between the first LPAP first daisy-chain port and the first LPAP charging port. The first DC-DC converter is configured to be controlled by the first LPAP controller. The second LPAP further may include a second DC-DC converter connected between the second LPAP first daisy-chain port and the second LPAP charging port. The second DC-DC converter is configured to be controlled by the second LPAP controller.

In another aspect of the present disclosure, the first LPAP controller and the second LPAP controller are further programmed to identify a highest battery voltage among the first electric vehicle and the second electric vehicle. The first LPAP controller and the second LPAP controller are further programmed to control the DC charger, the first DC-DC converter of the first LPAP, and the second DC-DC converter of the second LPAP to charge one or more of: the first electric vehicle and the second electric vehicle based at least in part on the highest battery voltage. The first LPAP controller and the second LPAP controller are further programmed to periodically re-evaluate the battery voltage of the first electric vehicle and the second electric vehicle, identify the highest battery voltage, and control the DC charger, the first DC-DC converter of the first LPAP, and the second DC-DC converter of the second LPAP to charge one or more of: the first electric vehicle and the second electric vehicle based at least in part on the highest battery voltage.

In another aspect of the present disclosure, to control the DC charger, the first DC-DC converter of the first LPAP, and the second DC-DC converter of the second LPAP, the first LPAP controller and the second LPAP controller are further programmed to command the DC charger to provide a second output voltage at the DC charger charging port using the first LPAP controller. The second output voltage is determined based at least in part on the highest battery voltage. To control the DC charger, the first DC-DC converter of the first LPAP, and the second DC-DC converter of the second LPAP, the first LPAP controller and the second LPAP controller are further programmed to determine a first voltage difference between the second output voltage and the battery voltage of the first electric vehicle. To control the DC charger, the first DC-DC converter of the first LPAP, and the second DC-DC converter of the second LPAP, the first LPAP controller and the second LPAP controller are further programmed to determine a second voltage difference between the second output voltage and the battery voltage of the second electric vehicle. To control the DC charger, the first DC-DC converter of the first LPAP, and the second DC-DC converter of the second LPAP, the first LPAP controller and the second LPAP controller are further programmed to control the first DC-DC converter of the first LPAP based at least in part on the first voltage difference. To control the DC charger, the first DC-DC converter of the first LPAP, and the second DC-DC converter of the second LPAP, the first LPAP controller and the second LPAP controller are further programmed to control the second DC-DC converter of the second LPAP based at least in part on the second voltage difference.

According to several aspects, a method for direct current (DC) charging for electric vehicles is provided. The method may include determining a battery voltage of each of a plurality of electric vehicles. Each of the plurality of electric vehicles is connected to one of a plurality of low-power access points (LPAPs). The plurality of LPAPs are connected in series to a DC charger. The method further may include controlling the DC charger and one or more of the plurality of LPAPs to charge one or more of the plurality of electric vehicles based at least in part on the battery voltage of each of the plurality of electric vehicles.

In another aspect of the present disclosure, the method further may include identifying a lowest battery voltage among the plurality of electric vehicles. The method further may include commanding the DC charger to provide a first output voltage. The first output voltage is determined based at least in part on the lowest battery voltage. The method further may include controlling an electronically controllable switch of one or more of the plurality of LPAPs to charge one or more of the plurality of electric vehicles having the lowest battery voltage. The method further may include periodically re-evaluating the battery voltage of each of the plurality of electric vehicles, identifying the lowest battery voltage, commanding the DC charger, and controlling the electronically controllable switch of one or more of the plurality of LPAPs to charge one or more of the plurality of electric vehicles having the lowest battery voltage.

In another aspect of the present disclosure, the method further may include identifying a highest battery voltage among the plurality of electric vehicles. The method further may include commanding the DC charger to provide a second output voltage. The second output voltage is determined based at least in part on the highest battery voltage. The method further may include controlling a DC-DC converter of each of the plurality of LPAPs to charge each of the plurality of electric vehicles based at least in part on the battery voltage of each of the plurality of electric vehicles. Controlling the DC-DC converter of each of the plurality of LPAPs further may include determining a plurality of voltage differences between the second output voltage and the battery voltage of each of the plurality of electric vehicles. The method further may include controlling the DC-DC converter of each of the plurality of LPAPs based at least in part on one of the plurality of voltage differences. The method further may include periodically re-evaluating the battery voltage of each of the plurality of electric vehicles, identifying the highest battery voltage, commanding the DC charger, and controlling the DC-DC converter of each of the plurality of LPAPs to charge each of the plurality of electric vehicles.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for direct current (DC) charging for electric vehicles, according to an exemplary embodiment;

FIG. 2 is a schematic diagram of a plurality of low-power access points (LPAPs) with a DC charger, according to an exemplary embodiment;

FIG. 3 is a flowchart of a first method for DC charging for electric vehicles, according to an exemplary embodiment; and

FIG. 4 is a flowchart of a second method for DC charging for electric vehicles, according to an exemplary embodiment.

### DETAILED DESCRIPTION

The following description is merely exemplary in nature and is not intended to limit the present disclosure, application, or uses.

In aspects of the present disclosure, as consumer adoption of electric vehicles increases, the need for effective charging infrastructure also increases. Electric vehicle supply equipment (EVSE) is often complex and resource intensive to install and maintain. Furthermore, EVSE is often designed to charge one electric vehicle at a time. Therefore, the present disclosure provides a new and improved system and method for direct current (DC) charging for electric vehicles which allows multiple vehicles to be supplied by one EVSE unit.

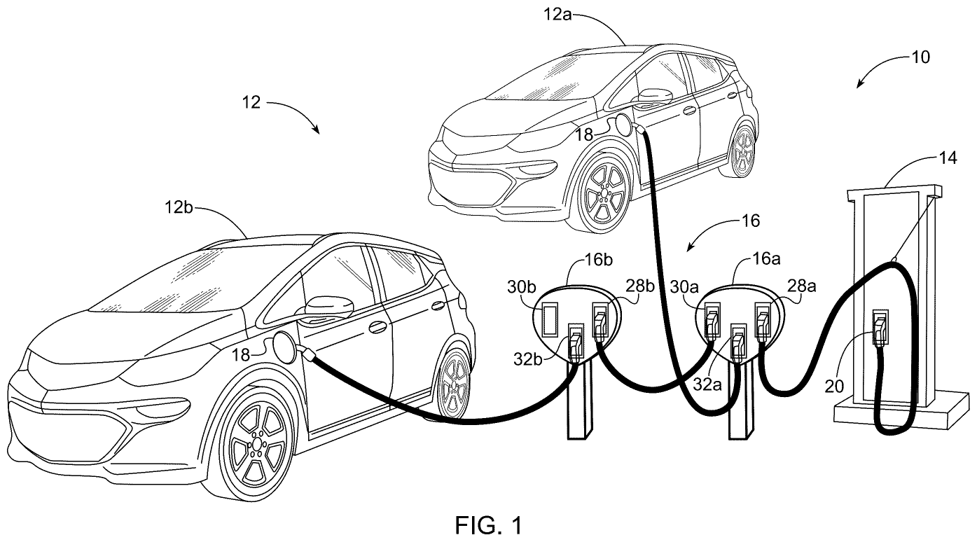

Referring to FIG. 1, a system for direct current (DC) charging for electric vehicles is illustrated and generally indicated by reference number 10. The system 10 is shown with an exemplary plurality of vehicles 12. While a plurality of passenger vehicles are illustrated, it should be appreciated that the plurality of vehicles 12 may include various types of vehicles without departing from the scope of the present disclosure. The system 10 generally includes a DC charger 14 and a plurality of low-power access points (LPAPs) 16.

In an exemplary embodiment, the plurality of vehicles 12 includes electric vehicles, hybrid electric vehicles, plug-in-hybrid electric vehicles, and/or the like. In an exemplary embodiment discussed in the present disclosure, the plurality of vehicles 12 includes a first vehicle 12a and a second vehicle 12b. It should be understood that the plurality of vehicles 12 generally may include any number of vehicles. While passenger vehicles are discussed in the present disclosure, it should be understood that the plurality of vehicles 12 may also include additional types of electric vehicles such as, for example, electric motorcycles, electric off-road vehicles, electric watercraft, electric aircraft, electric recreational vehicles, electric trucks, electric mass-transit vehicles (e.g., buses, trains, and/or the like) and/or additional electric machinery.

Each of the plurality of vehicles 12 has a vehicle power system (not shown) including at least a vehicle battery, a battery management system (BMS), and a vehicle charging port 18. In some examples, the vehicle power system further includes additional power electronics such as, for example, a rectifier to enable alternating current (AC) charging, a DC-DC converter to enable variable-voltage DC charging, and/or the like.

The vehicle battery stores and provides electrical energy in the form of direct current (DC) for propulsion of each of the plurality of vehicles 12. In an exemplary embodiment, the vehicle battery includes a plurality of battery cells (e.g., lithium-ion battery cells) electrically connected in series and/or parallel to provide an increased voltage and/or current-carrying capacity. In a non-limiting example, the plurality of battery cells are housed in an enclosure configured to protect the plurality of battery cells from mechanical vibration, water intrusion, and dust intrusion. The enclosure is also configured to provide temperature regulation (e.g., using a liquid cooling system, a resistive heating system, and/or the like).

The BMS is used to monitor and manage the vehicle battery to ensure the safe operation, optimal performance, and longevity of the vehicle battery. In a non-limiting example, the BMS includes voltage sensors, current sensors, temperature sensors, balancing circuits, contactors, and a battery control unit (BCU). The voltage sensors measure the voltage of individual battery cells within the vehicle battery. The current sensors measure current flowing into and out of the vehicle battery. The temperature sensors monitor thermal conditions. The balancing circuits are used to ensure that all battery cells maintain an equal state of charge. The contactors are used to control current flow between the vehicle battery and electrical loads (e.g., a traction motor).

The BCU is used to collect data from the sensors and control the contactors and the balancing circuits to manage the charging, discharging, and balancing processes. In a non-limiting example, the BCU is a controller including a processor (not shown), a non-transitory memory (not shown), and an interface (e.g., general purpose input-output (GPIO) pins, a serial interface, an analog-to-digital converter, and/or the like) (not shown). The non-transitory memory includes program instructions, which, when executed by the processor, command the BCU to collect data from the sensors and control the contactors and the balancing circuits via the interface. In a non-limiting example, the program instructions further allow for determination of battery characteristics such as a state of charge (SOC), state of health (SOH), and/or the like based on the data collected from the sensors.

In an exemplary embodiment, the BMS regulates charging current and voltage during the charging process to prevent overcharging, overheating, and other conditions that could damage the battery cells. In a non-limiting example, the BMS communicates with electric vehicle supply equipment (EVSE) connected to the vehicle charging port 18 to control charging parameters such as, for example, charging voltage, charging current, charging power, rate of charge, and/or the like. The BMS ensures that the charging process is conducted within applicable temperature and voltage limits by dynamically adjusting the charging parameters based on real-time data from the sensors.

The vehicle charging port 18 is used to enable connection between the vehicle power system and the EVSE to charge the vehicle battery. In general, the vehicle charging port 18 includes a plurality of pins for establishing electrical communication with the EVSE. In the scope of the present disclosure, electrical communication includes power and/or energy transfer between electrical devices (e.g., using conducting wires and/or wireless power transmission techniques) and information and/or data transfer between electrical devices (e.g., using a CAN network, a FLEXRAY network, a local area network (e.g., WiFi, ethernet, and the like), a serial peripheral interface (SPI) network, or the like).

In an exemplary embodiment, the vehicle charging port 18 includes two or more current conducting pins, at least one protective earth pin, and at least one communication pin. The two or more current conducting pins are used for transmission of power between the EVSE and the vehicle battery to charge the vehicle battery and/or provide power from the vehicle battery to the grid. The protective earth pin provides a protective ground connection.

The at least one communication pin allows the BMS to communicate with the EVSE to control charging parameters, as discussed above. In an exemplary embodiment, the at least one communication pin includes a proximity pilot (PP) pin and a control pilot (CP) pin. The PP pin is primarily used to detect a connection between the vehicle charging port 18 and the EVSE. The CP pin is used for communication of charging parameters between the BMS and the EVSE. In a non-limiting example, after detection of the EVSE using the PP pin, the BMS controls a resistance between the CP pin and the protective earth pin to indicate a charging status (e.g., standby, vehicle detected, ready (charging), error, and/or the like).

After continuity between the CP pin and the protective earth pin is detected, the EVSE transmits a variable pulse-width-modulated (PWM) square wave signal over the CP pin. The duty cycle of the PWM square wave indicates a maximum charging current available from the EVSE. In some embodiments, the duty cycle of the PWM square wave is also used to indicate additional information or provide commands. In a non-limiting example, the EVSE may request a high-frequency digital communication protocol (e.g., as specified in International Organization for Standardization (ISO) 15118, Society of Automotive Engineers (SAE) J2931/4, and/or German Institute for Standardization (DIN) 70121) by providing a specific duty cycle (e.g., five percent). Subsequently, the EVSE and the BMS may switch to the high-frequency digital communication protocol, allowing for transmission of additional information and charging parameters.

It should be understood that the above description of the vehicle charging port 18, including the configuration and function of the plurality of pins, is merely exemplary in nature. Any electric vehicle charging connector capable of transmitting energy and establishing communication between the EVSE and the vehicle power system is within the scope of the present disclosure. In a non-limiting example, the vehicle charging port 18 is realized according to specifications such as SAE J1772, SAE J3400, and/or the like. In a non-limiting example, the communication between the EVSE and the vehicle power system is realized according to specifications such as International Electrotechnical Commission (IEC) 61851, ISO 15118, DIN 70121, SAE J2847/2, SAE J2931/4, and/or the like.

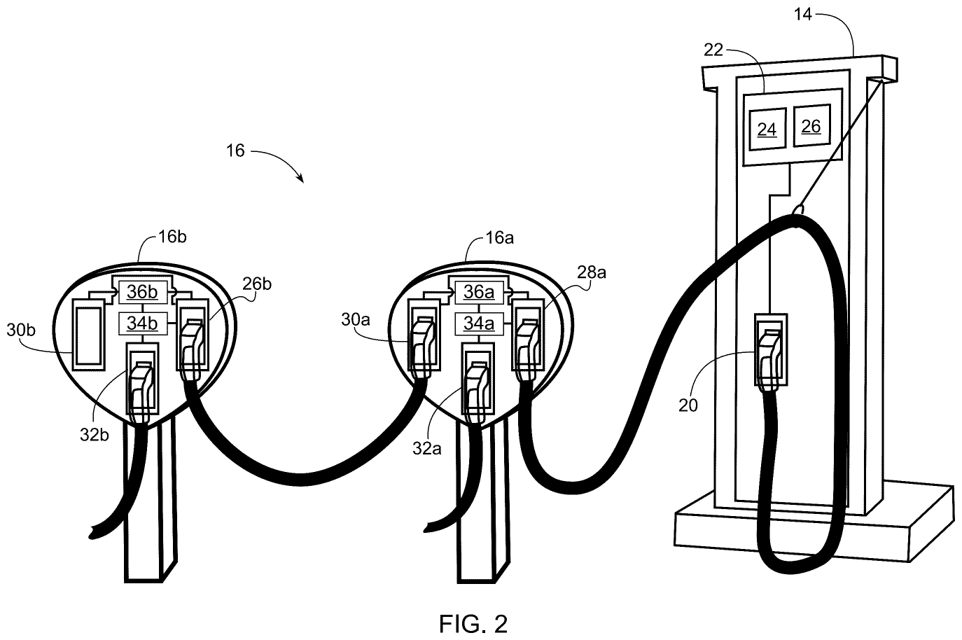

The DC charger 14 is an EVSE used to charge an electric vehicle (e.g., one of the plurality of vehicles 12). In an exemplary embodiment, the DC charger 14 includes a rectifier (not shown) connected to an AC power supply (e.g., a utility power grid, a portable generator, or other source of electrical power), a power control unit (not shown), a DC charger charging port 20, and a charge control unit (CCU) 22 (FIG. 2).

The rectifier is used to convert the AC power supply to DC power. In an exemplary embodiment, the rectifier is a full-wave bridge rectifier. In a non-limiting example, the full-wave bridge rectifier includes four diodes arranged in a bridge configuration. The diodes are arranged such that during each half-cycle of the AC input, two diodes conduct while the other two do not, allowing current to pass in a single direction. The result is a pulsating DC output, which can then be further smoothed by capacitors or other filtering components to provide a steady DC voltage to the power control unit. The rectifier is in electrical communication with the AC power supply and the power control unit.

The power control unit is used to control DC power output to a connected electric vehicle. In an exemplary embodiment, the power control unit includes one or more electronically controllable switches and one or more DC-DC converters. The one or more electronically controllable switches are used to control current flow between the DC charger 14 and the connected electric vehicle. In a non-limiting example, the one or more electronically controllable switches are transistors, relays, contactors, and/or the like. The one or more DC-DC converters are used to control the voltage and current provided to the connected electric vehicle. The power control unit is in electrical communication with the rectifier, the DC charger charging port 20, and the CCU 22.

The DC charger charging port 20 is used to enable connection between DC charger 14 and the vehicle charging port 18 to charge the vehicle battery. In general, the DC charger charging port 20 includes a plurality of pins for establishing electrical communication with the corresponding pins in the vehicle charging port 18 via a charging cable. In an exemplary embodiment, the DC charger charging port 20 includes two or more current conducting pins, at least one protective earth pin, and at least one communication pin. The two or more current conducting pins are used for transmission of power between the DC charger 14 and the vehicle charging port 18 to charge the vehicle battery and/or provide power from the vehicle battery to the grid. The protective earth pin provides a protective ground connection. The function of the at least one communication pin and an exemplary communication schema between the DC charger 14 and a connected electric vehicle are discussed above in reference to the vehicle charging port 18.

It should be understood that the above description of the DC charger charging port 20, including the configuration and function of the plurality of pins, is merely exemplary in nature. Any electrical connector capable of transmitting energy and establishing communication between the DC charger 14 and an electric vehicle is within the scope of the present disclosure. In a non-limiting example, the DC charger charging port 20 is realized according to specifications such as SAE J1772, SAE J3400, and/or the like. In a non-limiting example, the communication between the DC charger 14 and a connected electric vehicle is realized according to specifications such as IEC 61851, ISO 15118, DIN 70121, SAE J2847/2, SAE J2931/4, and/or the like, as discussed above.

The CCU is used to control the operation of the DC charger 14. The CCU 22 includes at least one processor 24 (FIG. 2) and a non-transitory computer readable storage device or media 26 (FIG. 2). The processor 24 may be a custom made or commercially available processor, a central processing unit (CPU), a graphics processing unit (GPU), an auxiliary processor among several processors associated with the CCU 22, a semiconductor-based microprocessor (in the form of a microchip or chip set), a macroprocessor, a combination thereof, or generally a device for executing instructions.

The computer readable storage device or media 26 may include volatile and nonvolatile storage in read-only memory (ROM), random-access memory (RAM), and keep-alive memory (KAM), for example. KAM is a persistent or non-volatile memory that may be used to store various operating variables while the processor 24 is powered down. The computer-readable storage device or media 26 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the CCU 22 to control the power control unit (i.e., control the operation of the one or more electronically controllable switches and the one or more DC-DC converters) and communicate with the connected electric vehicle as discussed above in reference to the vehicle charging port 18. In a non-limiting example, the CCU 22 is programmed to communicate with the connected electric vehicle according to specifications such as IEC 61851, ISO 15118, DIN 70121, SAE J2847/2, SAE J2931/4, and/or the like, as discussed above. The CCU 22 is in electrical communication with the DC charger charging port 20 to send/receive data to/from the connected electric vehicle. The CCU 22 is further in electrical communication with the power control unit to control the charging parameters (e.g., current and voltage limits) according to instructions received from the connected electric vehicle.

The plurality of low-power access points (LPAPs) 16 are used to allow connection of multiple electric vehicles (e.g., the plurality of electric vehicles) to a single DC EVSE (e.g., the DC charger 14) and transfer energy between the single DC EVSE and multiple electric vehicles. In an exemplary embodiment, the plurality of LPAPs 16 includes a first LPAP 16a and a second LPAP 16b. For the sake of clarity, the plurality of LPAPs 16 will primarily be discussed in terms of the first LPAP 16a and the second LPAP 16b. It should be understood, however, that the plurality of LPAPs 16 may include any number of LPAPs, and that the following disclosure, including disclosure of the structure and function of the first LPAP 16a and the second LPAP 16b, is applicable to systems including any number of LPAPs.

Referring to FIG. 2, an exemplary embodiment of the plurality of LPAPs 16 is shown with the DC charger 14. In an exemplary embodiment, the first LPAP 16a includes a first LPAP first daisy-chain port 28a, a first LPAP second daisy-chain port 30a, a first LPAP charging port 32a, a first LPAP power electronics module 34a, and a first LPAP controller 36a.

The first LPAP first daisy-chain port 28a and the first LPAP second daisy-chain port 30a are used for interconnection between the plurality of LPAPs 16 and connection of the plurality of LPAPs 16 with the DC charger 14. The first LPAP first daisy-chain port 28a and the first LPAP second daisy-chain port 30a may be realized using any electrical connector providing both current carrying conductors and communication conductors for communication with the DC charger 14. In a non-limiting example, the first LPAP first daisy-chain port 28a and the first LPAP second daisy-chain port 30a are realized according to specifications such as SAE J1772, SAE J3400, and/or the like. In an exemplary embodiment, the first LPAP first daisy-chain port 28a and the first LPAP second daisy-chain port 30a are further used for communication between LPAP controllers. In a non-limiting example, the first LPAP first daisy-chain port 28a and the first LPAP second daisy-chain port 30a include one or more additional communication pins dedicated for communication between LPAP controllers.

In an exemplary embodiment, the first LPAP 16a is connected in series with the plurality of LPAPs 16 (i.e., the second LPAP 16b) and the DC charger 14 using the first LPAP first daisy-chain port 28a and the first LPAP second daisy-chain port 30a. In an exemplary embodiment, the first LPAP 16a includes a low-impedance connection between the first LPAP first daisy-chain port 28a and the first LPAP second daisy-chain port 30a, such that the plurality of LPAPs 16 are effectively connected in parallel to the DC charger 14. In a non-limiting example, the first LPAP first daisy-chain port 28a is connected to the DC charger charging port 20 using a charging cable. The first LPAP second daisy-chain port 30a is connected to the second LPAP 16b using a charging cable.

The first LPAP charging port 32a is used to connect an electric vehicle (e.g., the first vehicle 12a) to the first LPAP 16a. The first LPAP charging port 32a may be realized using any electrical connector providing both current carrying conductors and communication conductors for communication with the vehicle charging port 18. In a non-limiting example, the first LPAP charging port 32a is realized according to specifications such as SAE J1772, SAE J3400, and/or the like. The first LPAP charging port 32a is connected to the vehicle charging port 18 of the first vehicle 12a using a charging cable (FIG. 1).

The first LPAP power electronics module 34a is used to control current flow between the first LPAP first daisy-chain port 28a and the first LPAP charging port 32a. In a first exemplary embodiment, the first LPAP power electronics module 34a is an electronically controllable switch (e.g., one or more transistors, relays, contactors, and/or the like). The electronically controllable switch is configured to be controlled by the first LPAP controller 36a, as will be discussed in greater detail below. In a second exemplary embodiment, the first LPAP power electronics module 34a is a DC-DC converter (e.g., a buck converter, a boost converter, a buck-boost converter, a flyback converter, and/or the like). The DC-DC converter is configured to be controlled by the first LPAP controller 36a, as will be discussed in greater detail below.

The first LPAP controller 36a is used to control the first LPAP power electronics module 34a, communicate with the first vehicle 12a, and communicate with the DC charger 14. In an exemplary embodiment, the first LPAP controller 36a is similar in structure and function to the CCU 22 discussed above, having a processor (not shown) and a non-transitory memory (not shown). In an exemplary embodiment, the first LPAP controller 36a executes a first method 100a and/or a second method 100b for DC charging for electric vehicles, as will be discussed in greater detail below. In a non-limiting example, because the first LPAP 16a is directly connected to the DC charger 14, the first LPAP controller 36a is designated as a primary LPAP controller and communicates with the DC charger 14 on behalf of each of the plurality of LPAPs 16. In an exemplary embodiment, the first LPAP controller 36a is further configured to communicate with additional LPAP controllers. In a non-limiting example, the first LPAP controller 36a uses dedicated LPAP communication pins for communication between LPAP controllers.

In an exemplary embodiment, the second LPAP 16b includes a second LPAP first daisy-chain port 28b, a second LPAP second daisy-chain port 30b, a second LPAP charging port 32b, a second LPAP power electronics module 34b, and a second LPAP controller 36b.

The second LPAP first daisy-chain port 28b and the second LPAP second daisy-chain port 30b are used for interconnection between the plurality of LPAPs 16 and connection of the plurality of LPAPs 16 with the DC charger 14. The second LPAP first daisy-chain port 28b and the second LPAP second daisy-chain port 30b may be realized using any electrical connector providing both current carrying conductors and communication conductors for communication with the DC charger 14. In a non-limiting example, the second LPAP first daisy-chain port 28b and the second LPAP second daisy-chain port 30b are realized according to specifications such as SAE J1772, SAE J3400, and/or the like. In an exemplary embodiment, the second LPAP first daisy-chain port 28b and the second LPAP second daisy-chain port 30b are further used for communication between LPAP controllers. In a non-limiting example, the second LPAP first daisy-chain port 28b and the second LPAP second daisy-chain port 30b include one or more additional communication pins dedicated for communication between LPAP controllers.

In an exemplary embodiment, the second LPAP 16b is connected in series with the plurality of LPAPs 16 (i.e., the first LPAP 16a) and the DC charger 14 using the second LPAP first daisy-chain port 28b and the second LPAP second daisy-chain port 30b. In an exemplary embodiment, the second LPAP 16b includes a low-impedance connection between the second LPAP first daisy-chain port 28b and the second LPAP second daisy-chain port 30b, such that the plurality of LPAPs 16 are effectively connected in parallel to the DC charger 14. In a non-limiting example, the second LPAP first daisy-chain port 28b is connected to the first LPAP second daisy-chain port 30a using a charging cable. The second LPAP second daisy-chain port 30b may be connected to a third LPAP (not shown) using a charging cable.

The second LPAP charging port 32b is used to connect an electric vehicle (e.g., the second vehicle 12b) to the second LPAP 16b. The second LPAP charging port 32b may be realized using any electrical connector providing both current carrying conductors and communication conductors for communication with the vehicle charging port 18. In a non-limiting example, the second LPAP charging port 32b is realized according to specifications such as SAE J1772, SAE J3400, and/or the like. The second LPAP charging port 32b is connected to the vehicle charging port 18 of the second vehicle 12b using a charging cable (FIG. 1).

The second LPAP power electronics module 34b is used to control current flow between the second LPAP first daisy-chain port 28b and the second LPAP charging port 32b. In a first exemplary embodiment, the second LPAP power electronics module 34b is an electronically controllable switch (e.g., one or more transistors, relays, contactors, and/or the like). The electronically controllable switch is configured to be controlled by the second LPAP controller 36b, as will be discussed in greater detail below. In a second exemplary embodiment, the second LPAP power electronics module 34b is a DC-DC converter (e.g., a buck converter, a boost converter, a buck-boost converter, a flyback converter, and/or the like). The DC-DC converter is configured to be controlled by the second LPAP controller 36b, as will be discussed in greater detail below.

The second LPAP controller 36b is used to control the second LPAP power electronics module 34b, communicate with the second vehicle 12b, and communicate with the first LPAP 16a. In an exemplary embodiment, the second LPAP controller 36b is similar in structure and function to the CCU 22 discussed above, having a processor (not shown) and a non-transitory memory (not shown). In an exemplary embodiment, the second LPAP controller 36b executes the first method 100a and/or the second method 100b for DC charging for electric vehicles, as will be discussed in greater detail below. In a non-limiting example, the second LPAP controller 36b is designated as a secondary LPAP controller and relays communications to the DC charger 14 through the first LPAP controller 36a. In an exemplary embodiment, the second LPAP controller 36b is further configured to communicate with additional LPAP controllers. In a non-limiting example, the second LPAP controller 36b uses dedicated LPAP communication pins for communication between LPAP controllers.

It should be understood that each of the plurality of LPAPs 16 are similar or identical in structure and function, such that the system 10 may be modularly expanded to include any number of LPAPs. In the embodiment discussed above, each of the plurality of LPAPs 16 includes an individual LPAP controller operating in coordination with the other LPAP controllers to execute the first method 100a and/or the second method 100b. In another exemplary embodiment, the system 10 includes a single, centralized LPAP controller in wireless and/or wired communication with each of the plurality of LPAPs. In a non-limiting example, the centralized LPAP controller is realized as a separate module or unit in electrical communication with each of the plurality of LPAPs. In another non-limiting example, the centralized LPAP controller is integrated into the DC charger 14. In a non-limiting example, the functions of the centralized LPAP controller are performed by the CCU 22 of the DC charger 14. It should be understood that any control schema for the plurality of LPAPs 16, including independent LPAP controllers (i.e., the first LPAP controller 36a and the second LPAP controller 36b) and/or one or more centralized LPAP controllers, is within the scope of the present disclosure.

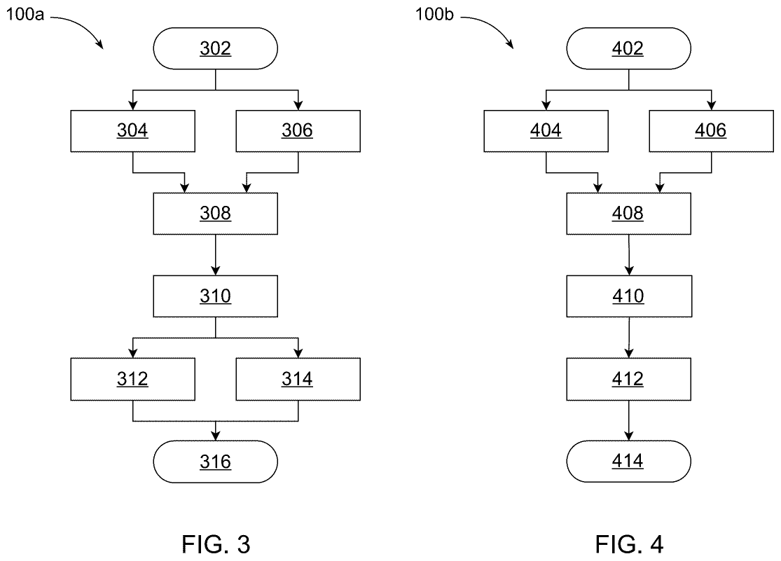

Referring to FIG. 3, a flowchart of the first method 100a for DC charging for electric vehicles is shown. The first method 100a is used for the embodiment where the LPAP power electronics module of each of the plurality of LPAPs 16 (i.e., the first LPAP power electronics module 34a and the second LPAP power electronics module 34b or any number of LPAP power electronics modules) is an electronically controllable switch. In an exemplary embodiment, the first method 100a is performed by the independent LPAP controllers (i.e., the first LPAP controller 36a and the second LPAP controller 36b or any number of LPAP controllers) or the one or more centralized LPAP controllers. For the sake of explanation, the first method 100a will be discussed in terms of the plurality of LPAPs 16. It should be understood that the following disclosure is also applicable to the one or more centralized LPAP controllers. In a non-limiting example, when the first method 100a is performed by the independent LPAP controllers (i.e., the first LPAP controller 36a and the second LPAP controller 36b), the independent LPAP controllers communicate with each other to exchange information while executing the first method 100a. The first method 100a begins at block 302 and proceeds to blocks 304 and 306.

At block 304, the plurality of LPAPs 16 determine a battery voltage of each of the plurality of vehicles 12. In an exemplary embodiment, the first LPAP controller 36a determines the battery voltage of the first vehicle 12a and the second LPAP controller 36b determines the battery voltage of the second vehicle 12b. In a non-limiting example, to determine the battery voltage, the plurality of LPAPs 16 communicate with the BMS of the vehicle power system of each of the plurality of vehicles 12. For example, the first LPAP controller 36a communicates with the BMS of the first vehicle 12a using the connection between the first LPAP charging port 32a and the vehicle charging port 18 of the first vehicle 12a. The second LPAP controller 36b communicates with the BMS of the second vehicle 12b using the connection between the second LPAP charging port 32b and the vehicle charging port 18 of the second vehicle 12b. After block 304, the first method 100a proceeds to block 308, as will be discussed in greater detail below.

At block 306, the plurality of LPAPs 16 determine charging parameter constraints of each of the plurality of vehicles 12. In the scope of the present disclosure, charging parameter constraints include for example, minimum/maximum charging voltage, minimum/maximum charging current, minimum/maximum charging power, minimum/maximum rate of charge, and/or the like. In an exemplary embodiment, the first LPAP controller 36a determines the charging parameter constraints of the first vehicle 12a and the second LPAP controller 36b determines the charging parameter constraints of the second vehicle 12b. In a non-limiting example, to determine the charging parameter constraints, the plurality of LPAPs 16 communicate with the BMS of the vehicle power system of each of the plurality of vehicles 12.

For example, the first LPAP controller 36a communicates with the BMS of the first vehicle 12a using the connection between the first LPAP charging port 32a and the vehicle charging port 18 of the first vehicle 12a. The second LPAP controller 36b communicates with the BMS of the second vehicle 12b using the connection between the second LPAP charging port 32b and the vehicle charging port 18 of the second vehicle 12b. After block 306, the first method 100a proceeds to block 308.

At block 308, the plurality of LPAPs 16 identify a lowest battery voltage among the plurality of vehicles 12. In an exemplary embodiment, the lowest battery voltage is determined by comparing the battery voltages determined at block 304. In a non-limiting example, the plurality of LPAPs 16 communicate with each other to compare the battery voltages determined at block 304. After block 308, the first method 100a proceeds to block 310.

At block 310, the plurality of LPAPs 16 command the DC charger 14 to provide a first output voltage at the DC charger charging port 20. In an exemplary embodiment, the first LPAP controller 36a is designated as a primary LPAP controller and communicates with the DC charger 14 on behalf of each of the plurality of LPAPs 16. In an exemplary embodiment, the first output voltage is determined based at least in part on the lowest battery voltage determined at block 308. In a non-limiting example, the first output voltage is determined to be greater than or equal to the lowest battery voltage. In another exemplary embodiment, the first output voltage is determined based at least in part on the lowest battery voltage determined at block 308 and the charging parameter constraints determined at block 306. In a non-limiting example, the first output voltage is determined such that the one or more of the plurality of vehicles 12 having the lowest battery voltage does not exceed its maximum charging current.

In an exemplary embodiment, at block 310, the plurality of LPAPs 16 further command the DC charger 14 to limit a current supplied at the DC charger charging port 20 to a first output current. In an exemplary embodiment, the first output current is less than or equal to the maximum charging current of the one or more of the plurality of vehicles 12 having the lowest battery voltage and a lowest maximum charging current. After block 310, the first method 100a proceeds to blocks 312 and 314.

At block 312, the plurality of LPAPs 16 control the electronically controllable switch of one or more of the plurality of LPAPs 16 to charge one or more of the plurality of vehicles 12 having the lowest battery voltage. In a non-limiting example, if the first vehicle 12a has the lowest battery voltage as determined at block 308, the first LPAP controller 36a closes the electronically controllable switch of the first LPAP power electronics module 34a to connect the first vehicle 12a to the DC charger 14. In another non-limiting example, if the second vehicle 12b has the lowest battery voltage as determined at block 308, the second LPAP controller 36b closes the electronically controllable switch of the second LPAP power electronics module 34b to connect the second vehicle 12b to the DC charger 14. In another non-limiting example, if the first vehicle 12a and the second vehicle 12b both have the lowest battery voltage as determined at block 308 (e.g., within a predetermined tolerance, for example, five percent), first LPAP controller 36a closes the electronically controllable switch of the first LPAP power electronics module 34a and the second LPAP controller 36b closes the electronically controllable switch of the second LPAP power electronics module 34b, such that both the first vehicle 12a and the second vehicle 12b are simultaneously connected to the DC charger 14. After block 312, the first method 100a proceeds to enter a standby state at block 316.

At block 314, the plurality of LPAPs 16 control the electronically controllable switch of one or more of the plurality of LPAPs 16 to terminate charging of one or more of the plurality of vehicles 12 having a battery voltage greater than (e.g., by at least a predetermined threshold, for example, ten percent) the lowest battery voltage. In an exemplary embodiment, charging is terminated by opening the electronically controllable switch after appropriate communication with the one or more of the plurality of vehicles 12. After block 314, the first method 100a proceeds to enter a standby state at block 316.

In an exemplary embodiment, throughout the first method 100a, the first LPAP controller 36a emulates an electric vehicle during communications with the DC charger 14 (e.g., using the communication protocols and techniques discussed above). Therefore, the DC charger 14 operates as if a single electric vehicle were connected and provides charging power to the first LPAP first daisy-chain port 28a based on the data transferred between the first LPAP controller 36a and the DC charger 14. Furthermore, throughout the first method 100a, the plurality of LPAPs 16 emulate an EVSE during communications with the plurality of vehicles 12 (e.g., using the communication protocols and techniques discussed above).

The plurality of LPAPs 16 also intercept and act on any communications from the plurality of vehicles 12 which are directed to the DC charger 14. For example, if the first vehicle 12a sends a signal requesting that charging be terminated (e.g., when the first vehicle 12a reaches a maximum state of charge), the first LPAP controller 36a intercepts the signal and opens the electronically controllable switch of the first LPAP power electronics module 34a without affecting the charging process of the second vehicle 12b. For example, if the second vehicle 12b sends a signal requesting a change in charging voltage, the second LPAP controller 36b intercepts the signal and relays the signal to the first LPAP controller 36a. The first LPAP controller 36a subsequently communicates with the DC charger 14 to adjust the charging voltage.

In an exemplary embodiment, the plurality of LPAPs 16 repeatedly exit the standby state 316 and restart the first method 100a at block 302 such as to periodically re-evaluate the battery voltage of each of the plurality of vehicles 12, identify the lowest battery voltage, and control the DC charger 14 and one or more of the plurality of LPAPs 16 to charge one or more of the plurality of vehicles 12 having the lowest battery voltage. In a non-limiting example, the plurality of LPAPs 16 exit the standby state 316 and restart the first method 100a on a timer, for example, every three hundred milliseconds.

Referring to FIG. 4, a flowchart of the second method 100b for DC charging for electric vehicles is shown. The second method 100b is used for the embodiment where the LPAP power electronics module of each of the plurality of LPAPs 16 (i.e., the first LPAP power electronics module 34a and the second LPAP power electronics module 34b or any number of LPAP power electronics modules) includes a DC-DC converter. In an exemplary embodiment, the second method 100b is performed by the independent LPAP controllers (i.e., the first LPAP controller 36a and the second LPAP controller 36b or any number of LPAP controllers) or the one or more centralized LPAP controllers. For the sake of explanation, the second method 100b will be discussed in terms of the plurality of LPAPs 16. It should be understood that the following disclosure is also applicable to the one or more centralized LPAP controllers. In a non-limiting example, when the second method 100b is performed by the independent LPAP controllers (i.e., the first LPAP controller 36a and the second LPAP controller 36b), the independent LPAP controllers communicate with each other to exchange information while executing the second method 100b. The second method 100b begins at block 402 and proceeds to blocks 404 and 406.

At block 404, the plurality of LPAPs 16 determine a battery voltage of each of the plurality of vehicles 12. In an exemplary embodiment, the first LPAP controller 36a determines the battery voltage of the first vehicle 12a and the second LPAP controller 36b determines the battery voltage of the second vehicle 12b. In a non-limiting example, to determine the battery voltage, the plurality of LPAPs 16 communicate with the BMS of the vehicle power system of each of the plurality of vehicles 12. For example, the first LPAP controller 36a communicates with the BMS of the first vehicle 12a using the connection between the first LPAP charging port 32a and the vehicle charging port 18 of the first vehicle 12a. The second LPAP controller 36b communicates with the BMS of the second vehicle 12b using the connection between the second LPAP charging port 32b and the vehicle charging port 18 of the second vehicle 12b. After block 404, the second method 100b proceeds to block 408, as will be discussed in greater detail below.

At block 406, the plurality of LPAPs 16 determine charging parameter constraints of each of the plurality of vehicles 12. In the scope of the present disclosure, charging parameter constraints include for example, minimum/maximum charging voltage, minimum/maximum charging current, minimum/maximum charging power, minimum/maximum rate of charge, and/or the like. In an exemplary embodiment, the first LPAP controller 36a determines the charging parameter constraints of the first vehicle 12a and the second LPAP controller 36b determines the charging parameter constraints of the second vehicle 12b. In a non-limiting example, to determine the charging parameter constraints, the plurality of LPAPs 16 communicate with the BMS of the vehicle power system of each of the plurality of vehicles 12.

For example, the first LPAP controller 36a communicates with the BMS of the first vehicle 12a using the connection between the first LPAP charging port 32a and the vehicle charging port 18 of the first vehicle 12a. The second LPAP controller 36b communicates with the BMS of the second vehicle 12b using the connection between the second LPAP charging port 32b and the vehicle charging port 18 of the second vehicle 12b. After block 406, the second method 100b proceeds to block 408.

At block 408, the plurality of LPAPs 16 identify a highest battery voltage among the plurality of vehicles 12. In an exemplary embodiment, the highest battery voltage is determined by comparing the battery voltages determined at block 404. In a non-limiting example, the plurality of LPAPs 16 communicate with each other to compare the battery voltages determined at block 404. After block 408, the second method 100b proceeds to block 410.

At block 410, the plurality of LPAPs 16 command the DC charger 14 to provide a second output voltage at the DC charger charging port 20. In an exemplary embodiment, the first LPAP controller 36a is designated as a primary LPAP controller and communicates with the DC charger 14 on behalf of each of the plurality of LPAPs 16. In an exemplary embodiment, the second output voltage is determined based at least in part on the highest battery voltage determined at block 408. In a non-limiting example, the second output voltage is determined to be greater than or equal to the highest battery voltage.

In an exemplary embodiment, at block 410, the plurality of LPAPs 16 further command the DC charger 14 to limit a current supplied at the DC charger charging port 20 to a second output current. In an exemplary embodiment, the second output current is equal to a sum of the maximum charging current of each of the one or more of the plurality of vehicles 12. After block 410, the second method 100b proceeds to block 412.

At block 412, the plurality of LPAPs 16 control the DC-DC converter of each of the plurality of LPAPs 16 to charge each of the plurality of vehicles 12. In an exemplary embodiment, the DC-DC converter of each of the plurality of LPAPs 16 is controlled based at least in part on the battery voltage of each of the plurality of vehicles 12. In another exemplary embodiment, the DC-DC converter of each of the plurality of LPAPs 16 is controlled based at least in part on the battery voltage of each of the plurality of vehicles 12 and the second output voltage. In a non-limiting example, the plurality of LPAPs 16 determine a plurality of voltage differences between the second output voltage and the battery voltage of each of the plurality of vehicles 12. The plurality of LPAPs 16 then control the DC-DC converter of each of the plurality of LPAPs 16 based at least in part on one of the plurality of voltage differences.

In a non-limiting example, the duty cycle of the DC-DC converter of the first LPAP power electronics module 34a is controlled such that a voltage provided at the first LPAP charging port 32a matches the battery voltage of the first vehicle 12a (e.g., within a predetermined tolerance, for example, five percent). In a non-limiting example, the duty cycle of the DC-DC converter of the second LPAP power electronics module 34b is controlled such that a voltage provided at the second LPAP charging port 32b matches the battery voltage of the second vehicle 12b (e.g., within a predetermined tolerance, for example, five percent). After block 412, the second method 100b proceeds to enter a standby state at block 414.

In an exemplary embodiment, throughout the second method 100b, the first LPAP controller 36a emulates an electric vehicle during communications with the DC charger 14 (e.g., using the communication protocols and techniques discussed above). Therefore, the DC charger 14 operates as if a single electric vehicle were connected and provides charging power to the first LPAP first daisy-chain port 28a based on the data transferred between the first LPAP controller 36a and the DC charger 14. Furthermore, throughout the second method 100b, the plurality of LPAPs 16 emulate an EVSE during communications with the plurality of vehicles 12 (e.g., using the communication protocols and techniques discussed above).

The plurality of LPAPs 16 also intercept and act on any communications from the plurality of vehicles 12 which are directed to the DC charger 14. For example, if the first vehicle 12a sends a signal requesting that charging be terminated (e.g., when the first vehicle 12a reaches a maximum state of charge), the first LPAP controller 36a intercepts the signal and deactivates the DC-DC converter of the first LPAP power electronics module 34a without affecting the charging process of the second vehicle 12b. For example, if the second vehicle 12b sends a signal requesting a change in charging voltage, the second LPAP controller 36b intercepts the signal and adjusts the operation of the DC-DC converter of the second LPAP power electronics module 34b. If necessary, the second LPAP controller 36b relays the signal to the first LPAP controller 36a. The first LPAP controller 36a subsequently communicates with the DC charger 14 to adjust the charging voltage.

In an exemplary embodiment, the plurality of LPAPs 16 repeatedly exit the standby state 414 and restart the second method 100b at block 402 such as to periodically re-evaluate the battery voltage of each of the plurality of vehicles 12, identify the highest battery voltage, and control the DC charger 14 and one or more of the plurality of LPAPs 16 to charge the plurality of vehicles 12 based at least in part on the highest battery voltage. In a non-limiting example, the plurality of LPAPs 16 exit the standby state 414 and restart the second method 100b on a timer, for example, every three hundred milliseconds.

The system 10, the first method 100a, and the second method 100b of the present disclosure offer several advantages. The system 10 may be used to provide charging for a large number of electric vehicles with only a single DC EVSE. For example, multiple portable LPAPs may be temporarily installed to provide enhanced charging capability at an event or festival. Furthermore, LPAPs may be used to provide charging for multiple electric vehicles in remote areas when used in conjunction with a portable generator. Additionally, the system 10, first method 100a, and second method 100b are compatible with existing EVSE without hardware or software modification, because the plurality of LPAPs 16 work in conjunction to emulate a single electric vehicle using industry standard communications protocols.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for direct current (DC) charging for electric vehicles, the system comprising:
a DC charger having a DC charger charging port;
a plurality of low-power access points (LPAPs) each having a first daisy-chain port, a second daisy-chain port, and an LPAP charging port, wherein the plurality of LPAPs are connected in series to the DC charger charging port of the DC charger with the first daisy-chain port and the second daisy-chain port, and wherein each of the plurality of LPAPs is configured to transfer energy from the DC charger to an electric vehicle with the LPAP charging port; and
a plurality of electric vehicles, wherein each of the plurality of electric vehicles is connected to the LPAP charging port of one of the plurality of LPAPs to charge the plurality of electric vehicles.

2. The system of claim 1, further comprising:
an LPAP controller in electrical communication with each of the plurality of LPAPs, wherein the LPAP controller is programmed to:
determine a battery voltage of each of the plurality of electric vehicles; and
control the DC charger and one or more of the plurality of LPAPs to charge one or more of the plurality of electric vehicles based at least in part on the battery voltage of each of the plurality of electric vehicles.

3. The system of claim 2, wherein the LPAP controller is further programmed to:
identify a lowest battery voltage among the plurality of electric vehicles;
control the DC charger and one or more of the plurality of LPAPs to charge one or more of the plurality of electric vehicles having the lowest battery voltage; and
periodically re-evaluate the battery voltage of each of the plurality of electric vehicles, identify the lowest battery voltage, and control the DC charger and one or more of the plurality of LPAPs to charge one or more of the plurality of electric vehicles having the lowest battery voltage.

4. The system of claim 3, wherein at least one of the plurality of LPAPs further comprises:
an electronically controllable switch configured to connect the first daisy-chain port to the LPAP charging port, wherein the electronically controllable switch is configured to be controlled by the LPAP controller.

5. The system of claim 4, wherein to control the DC charger and one or more of the plurality of LPAPs, the LPAP controller is further programmed to:
command the DC charger to provide a first output voltage at the DC charger charging port, wherein the first output voltage is determined based at least in part on the lowest battery voltage; and
control the electronically controllable switch of one or more of the plurality of LPAPs to charge one or more of the plurality of electric vehicles having the lowest battery voltage.

6. The system of claim 5, wherein to control the DC charger and one or more of the plurality of LPAPs, the LPAP controller is further programmed to:
command the DC charger to limit a current at the DC charger charging port to a first output current, wherein the first output current is determined based at least in part on a maximum charging current of the one or more of the plurality of electric vehicles having the lowest battery voltage.

7. The system of claim 2, wherein the LPAP controller is further programmed to:
identify a highest battery voltage among the plurality of electric vehicles;
control the DC charger and one or more of the plurality of LPAPs to charge the plurality of electric vehicles based at least in part on the highest battery voltage; and
periodically re-evaluate the battery voltage of each of the plurality of electric vehicles, identify the highest battery voltage, and control the DC charger and one or more of the plurality of LPAPs to charge the plurality of electric vehicles based at least in part on the highest battery voltage.

8. The system of claim 7, wherein each of the plurality of LPAPs further comprises:
a DC-DC converter connected between the first daisy-chain port and the LPAP charging port, wherein the DC-DC converter is configured to be controlled by the LPAP controller.

9. The system of claim 8, wherein to control the DC charger and one or more of the plurality of LPAPs, the LPAP controller is further programmed to:
command the DC charger to provide a second output voltage at the DC charger charging port, wherein the second output voltage is determined based at least in part on the highest battery voltage; and
control the DC-DC converter of each of the plurality of LPAPs to charge each of the plurality of electric vehicles based at least in part on the battery voltage of each of the plurality of electric vehicles.

10. The system of claim 9, wherein to control the DC-DC converter of each of the plurality of LPAPs, the LPAP controller is further programmed to:
determine a plurality of voltage differences between the second output voltage and the battery voltage of each of the plurality of electric vehicles; and
control the DC-DC converter of each of the plurality of LPAPs based at least in part on one of the plurality of voltage differences.

11. A system for direct current (DC) charging for electric vehicles, the system comprising:
a DC charger having a DC charger charging port;
a first low-power access point (LPAP) having a first LPAP first daisy-chain port, a first LPAP second daisy-chain port, a first LPAP charging port, and a first LPAP controller, wherein the first LPAP first daisy-chain port is connected to the DC charger charging port;
a second low-power access point (LPAP) having a second LPAP first daisy-chain port, a second LPAP second daisy-chain port, a second LPAP charging port, and a second LPAP controller, wherein the second LPAP first daisy-chain port is connected to the first LPAP second daisy-chain port, and wherein the second LPAP controller is in electrical communication with the first LPAP controller;
wherein the first LPAP controller and the second LPAP controller are programmed to:
determine a battery voltage of a first electric vehicle connected to the first LPAP charging port and a second electric vehicle connected to the second LPAP charging port; and
control the DC charger, the first LPAP, and the second LPAP to charge one or more of: the first electric vehicle and the second electric vehicle based at least in part on the battery voltage of the first electric vehicle and the second electric vehicle.

12. The system of claim 11, wherein:
the first LPAP further comprises a first electronically controllable switch configured to connect the first LPAP first daisy-chain port to the first LPAP charging port, wherein the first electronically controllable switch is configured to be controlled by the first LPAP controller; and
the second LPAP further comprises a second electronically controllable switch configured to connect the second LPAP first daisy-chain port to the second LPAP charging port, wherein the second electronically controllable switch is configured to be controlled by the second LPAP controller.

13. The system of claim 12, wherein the first LPAP controller and the second LPAP controller are further programmed to:
identify a lowest battery voltage among the first electric vehicle and the second electric vehicle;
control the DC charger, the first electronically controllable switch of the first LPAP, and the second electronically controllable switch of the second LPAP to charge one or more of: the first electric vehicle and the second electric vehicle having the lowest battery voltage; and
periodically re-evaluate the battery voltage of the first electric vehicle and the second electric vehicle, identify the lowest battery voltage, and control the DC charger, the first electronically controllable switch of the first LPAP, and the second electronically controllable switch of the second LPAP to charge one or more of: the first electric vehicle and the second electric vehicle having the lowest battery voltage.

14. The system of claim 13, wherein to control the DC charger, the first electronically controllable switch of the first LPAP, and the second electronically controllable switch of the second LPAP, the first LPAP controller and the second LPAP controller are further programmed to:
command the DC charger to provide a first output voltage at the DC charger charging port using the first LPAP controller, wherein the first output voltage is determined based at least in part on the lowest battery voltage; and
control the first electronically controllable switch of the first LPAP and the second electronically controllable switch of the second LPAP to charge one or more of: the first electric vehicle and the second electric vehicle having the lowest battery voltage.

15. The system of claim 11, wherein:
the first LPAP further comprises a first DC-DC converter connected between the first LPAP first daisy-chain port and the first LPAP charging port, wherein the first DC-DC converter is configured to be controlled by the first LPAP controller; and
the second LPAP further comprises a second DC-DC converter connected between the second LPAP first daisy-chain port and the second LPAP charging port, wherein the second DC-DC converter is configured to be controlled by the second LPAP controller.

16. The system of claim 15, wherein the first LPAP controller and the second LPAP controller are further programmed to:
identify a highest battery voltage among the first electric vehicle and the second electric vehicle;
control the DC charger, the first DC-DC converter of the first LPAP, and the second DC-DC converter of the second LPAP to charge one or more of: the first electric vehicle and the second electric vehicle based at least in part on the highest battery voltage; and
periodically re-evaluate the battery voltage of the first electric vehicle and the second electric vehicle, identify the highest battery voltage, and control the DC charger, the first DC-DC converter of the first LPAP, and the second DC-DC converter of the second LPAP to charge one or more of: the first electric vehicle and the second electric vehicle based at least in part on the highest battery voltage.

17. The system of claim 16, wherein to control the DC charger, the first DC-DC converter of the first LPAP, and the second DC-DC converter of the second LPAP, the first LPAP controller and the second LPAP controller are further programmed to:
command the DC charger to provide a second output voltage at the DC charger charging port using the first LPAP controller, wherein the second output voltage is determined based at least in part on the highest battery voltage;
determine a first voltage difference between the second output voltage and the battery voltage of the first electric vehicle;
determine a second voltage difference between the second output voltage and the battery voltage of the second electric vehicle;
control the first DC-DC converter of the first LPAP based at least in part on the first voltage difference; and
control the second DC-DC converter of the second LPAP based at least in part on the second voltage difference.

18. A method for direct current (DC) charging for electric vehicles, the method comprising:
determining a battery voltage of each of a plurality of electric vehicles, wherein each of the plurality of electric vehicles is connected to one of a plurality of low-power access points (LPAPs), and wherein the plurality of LPAPs are connected in series to a DC charger; and
controlling the DC charger and one or more of the plurality of LPAPs to charge one or more of the plurality of electric vehicles based at least in part on the battery voltage of each of the plurality of electric vehicles.

19. The method of claim 18, further comprising:
identifying a lowest battery voltage among the plurality of electric vehicles;
commanding the DC charger to provide a first output voltage, wherein the first output voltage is determined based at least in part on the lowest battery voltage; and
controlling an electronically controllable switch of one or more of the plurality of LPAPs to charge one or more of the plurality of electric vehicles having the lowest battery voltage; and
periodically re-evaluating the battery voltage of each of the plurality of electric vehicles, identifying the lowest battery voltage, commanding the DC charger, and controlling the electronically controllable switch of one or more of the plurality of LPAPs to charge one or more of the plurality of electric vehicles having the lowest battery voltage.

20. The method of claim 18, further comprising:
identifying a highest battery voltage among the plurality of electric vehicles;
commanding the DC charger to provide a second output voltage, wherein the second output voltage is determined based at least in part on the highest battery voltage;
controlling a DC-DC converter of each of the plurality of LPAPs to charge each of the plurality of electric vehicles based at least in part on the battery voltage of each of the plurality of electric vehicles, wherein controlling the DC-DC converter of each of the plurality of LPAPs further comprises:
determining a plurality of voltage differences between the second output voltage and the battery voltage of each of the plurality of electric vehicles; and
controlling the DC-DC converter of each of the plurality of LPAPs based at least in part on one of the plurality of voltage differences; and
periodically re-evaluating the battery voltage of each of the plurality of electric vehicles, identifying the highest battery voltage, commanding the DC charger, and controlling the DC-DC converter of each of the plurality of LPAPs to charge each of the plurality of electric vehicles.
